(19) United States
(12) Patent Application Publication
(10) Pub. No.: US 2008/0259114 A1
(43) Pub. Date: Oct. 23, 2008

(54) PRINT HEAD CLEANING FLUID CONDENSATION

(75) Inventors: David A. Tyvoll, La Jolla, CA (US); Winthrop D. Childers, San Diego, CA (US); Phillip C. Cagle, San Marcos, CA (US); Pere J. Canti, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/738,400

(22) Filed: Apr. 20, 2007

(51) Int. Cl. B41J 2/165

(52) U.S. Cl. 347/22

(57) ABSTRACT

Various embodiments and methods relating to condensation of print head cleaning fluid upon a print head are disclosed.

### BACKGROUND

Performance of print heads may decline due to build up of residue. Measures to remove the residue may be ineffective, complex or expensive.

### BRIEF DESCRIPTION OF THE DRAWINGS

FIG. 1 is a schematic diagram, with portions shown in section, illustrating a printing system according to an example embodiment.

FIG. 2 is an enlarged sectional view of a print head cleaning unit of the printing system of FIG. 1 according to an example embodiment.

FIG. 3 is a top plan view of the print head cleaning unit of FIG. 2 according to an example embodiment.

FIG. 4 is a flow diagram of a method of servicing a print head according to an example embodiment.

FIG. 5 is a schematic diagram, with portions shown in section, illustrating another embodiment of the printing system of FIG. 1 according to an example embodiment.

FIG. 6 is a flow diagram of another method of servicing a print head according to an example embodiment.

FIG. 7 is a schematic diagram, with portions shown in section, illustrating another embodiment of the printing system of FIG. 1 according to an example embodiment.

FIG. 8 is an enlarged sectional view of a print head cleaning unit of the printing system of FIG. 7 according to an example embodiment.

### DETAILED DESCRIPTION OF THE EXAMPLE EMBODIMENTS

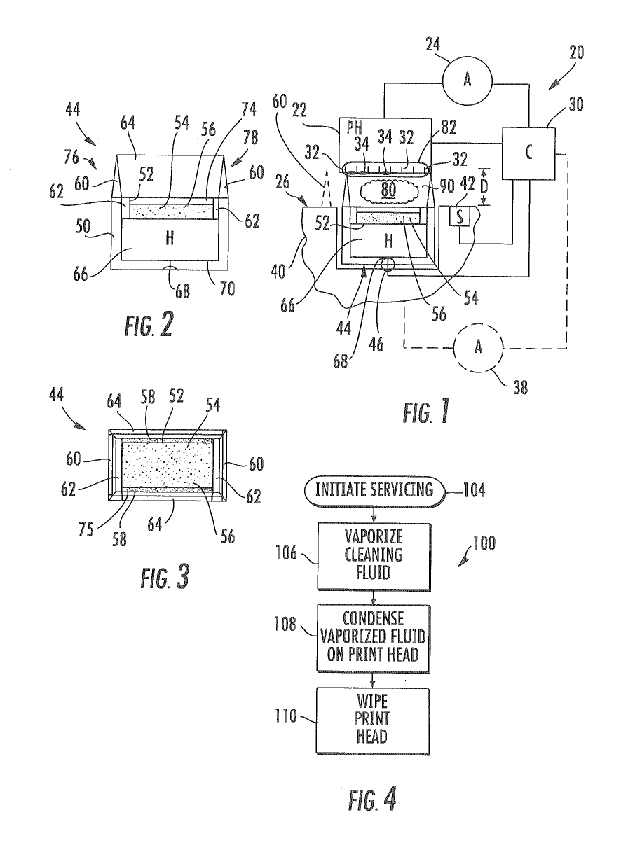

FIG. 1 is a schematic illustration of printing system 20 according to an example embodiment. Printing system 20 is configured to print upon a print medium with a print head 22. As will be described in more detail hereafter, printing system 20 additionally includes a service station 26 configured to service the print head 22 by facilitating removal of residue from print head 22. As will be described hereafter, service station 26 provides a less complex and less expensive system and method for effectively removing residue from print head 22, enhancing print quality.

Printing system 20 includes print head 22, actuator 24, print head service station 26 and controller 30. Print head 22 comprises one or more print heads having openings or nozzles 32 (schematically illustrated) through which fluid is ejected. Over time, such fluid may deposit and form residue 34 (schematically shown) adjacent to and upon nozzles 32. As noted above, such residue 34 may reduce print quality.

According to one example embodiment, print head 22 comprises a drop-on-demand inkjet print head. According to one embodiment, print head 22 comprises a thermoresistive inkjet print head. According to another embodiment, print head 22 comprises a piezo resistive inkjet print head. In one embodiment, print head 22 may be provided as part of an ink jet pen or cartridge. In another embodiment, print head 22 may have an off-axis ink supply.

Actuator 24 comprises a device configured to move or scan print head 22 across a medium being printed upon. In the particular example illustrated, actuator 24 is further configured to move print head 22 to a position substantially opposite to service station 26. In one embodiment, actuator 24 may comprise a motor operably coupled to a carriage (not shown) by a drive train (not shown), wherein the carriage supports print head 22. As indicated in broken lines, in other embodiments, actuator 24 may be omitted and print head 22 may be supported stationary, wherein printing system 20 alternatively includes an actuator 38 for moving service station 26 relative to print head 22. In one embodiment, actuator 38 may comprise a motor operably coupled to service station 26 by a drive train (not shown) so as to linearly move or translate service station 26 across print head 22. In some embodiments, actuator 38 may be additionally or alternatively configured to move service station 26 towards and away from print head 22. In one embodiment, print head 22 may comprise a page-wide-array print head that is supported in a stationary fashion while service station 26 is moved with respect to print head 22.

Service station 26 comprises a station configured to service print head 22 by facilitating removal of residue 34. Service station 26 includes support 40, sensor 42, and print head cleaning unit 44. Support 40 comprises a base, housing portion, frame or other structure configured to support sensor 42 and to removably support cleaning unit 44. In the particular example illustrated, support 40 includes a communication interface 46 facilitating communication between cleaning unit 44 and controller 30. As noted above, in one embodiment, support 40 may each configured to remain stationary with respect to a remainder of printing system 20 at all times. In another embodiment, support 40 may be movable such as with actuator 38.

Sensor 42 comprises a device configured to detect an extent of residue 34 upon print head 22. In one embodiment, sensor 42 comprises an optical sensor. In other embodiments, sensor 42 may comprise other types of sensing devices such as resistive sensors or temperature sensors. Although sensor 42 is illustrated as being supported by support 40 proximate to cleaning unit 44, in other embodiments, sensor 42 may be supported at other locations. In some embodiments, sensor 42 may be omitted such as where the initiation of servicing of print head 22 is based upon other criteria or is performed in a timed or periodic matter.

Cleaning unit 44 comprises a self-contained unit, cartridge or module configured to be removably inserted or removably connected to support 40 while being configured to facilitate servicing of print head 22. As a result, cleaning unit 44 may be removed and replaced or repaired as needed without time-consuming disassembly of printing system 20. In other embodiments, cleaning unit 44 may alternatively be more permanently secured to support 40 so as to be non-removable. For example, in other embodiments, cleaning unit 44 may be integrally formed with support 40 or welded, bonded or securely fastened to support 40.

FIGS. 2 and 3 are enlarged views of cleaning unit 44. FIG. 2 is a sectional view schematically illustrating cleaning unit 44. FIG. 3 is a top plan view of cleaning unit 44. Cleaning unit 44 includes body 50, reservoir 52, cleaning fluid 54, absorption member 56, over flow channels 58 (shown in FIG. 3), wiper blades 60, wiper channels 62, sidewalls 64, heating element 66 and communication interface 68. Body 50 comprises a frame, housing, enclosure or other structure configured to support the remaining elements of cleaning unit 44. Body 50 further configured to be removably positioned within or connected to support 40. In the particular example illustrated, body 50 includes an interior 70 which contains reservoir 52, cleaning fluid 54, absorption member 56 and heating element 66. Body 50 forms channels 58 and 62. Body 50 further supports blades 60 and sidewalls 64. In other embodiments, body 50 may have other configurations.

Reservoir 52 comprises a receptacle configured to contain and hold cleaning fluid 54 substantially opposite to print head 22 during servicing a print head 22 and in sufficient proximity to heating element 66 such that the cleaning fluid may be vaporized from heat emitted by heating element 66. Reservoir 52 is further configured to be positioned sufficiently close to nozzles 32 of print head 22 during such servicing such that the vaporized cleaning fluid condenses adjacent to and upon nozzles 32. As shown by FIG. 1, reservoir 52 is located such that its top opening is spaced from nozzles 32 (i.e., a nozzle plate of print head 22) by a distance D.

Cleaning fluid 54 comprises a fluid configured to be vaporized by heating element 66 and to condense upon print head 22 adjacent to nozzles 32. Cleaning fluid 54 is configured to facilitate removal of residue 34 (shown in FIG. 1) from print head 22. In one embodiment in which residue 34 results from a pigment-based ink, wherein residue 34 may largely comprise such pigment dispersions, cleaning fluid 54 is specifically configured to facilitate removal of such pigment residue. In one embodiment, cleaning fluid 54 comprises a humectant. Examples of humectants include, but are not limited to, glycerol, ethylene glycol, diethylene glycol, 2-pyrrolidinone and the like. In one embodiment, such humectants are configured to have a sufficient vapor pressure at modest operating temperatures. As a result, cleaning fluid 54 more easily vaporizes using compact and low-cost heating element 66. In other embodiments, cleaning fluid 54 may comprise other materials configured to loosen, soften, dissolve or otherwise facilitate removal of residue 34.

According to one embodiment, cleaning fluid 54 is provided in reservoir 52 prior to cleaning unit 44 being connected to or received within support 40. For example, in one embodiment, cleaning unit 44 may be sold as a cleaning cartridge already containing cleaning fluid 54. As shown by FIG. 2, cleaning unit 44 may additionally include a removable cover 74 configured to at least partially seal reservoir 52 to reduce evaporation of cleaning fluid 54 prior to use. In one embodiment, cover 74 may be reusable and replaceable for covering reservoir 52 when station 26 is not in use. In some embodiments, cover 74 may be a one-time-use cover that is disposable, such as a removable tape.

In other embodiments, cover 74 may be omitted. In still other embodiments, cleaning fluid 54 may be supplied to reservoir 52 after insertion of cleaning unit 44 into printing system 20 and after connection to support 40. For example, reservoir 52 may be at least partially filled cleaning fluid 54 from a cleaning fluid supply and fluid line (not shown) associated with printing system 20. As will be described hereafter, in another embodiment, reservoir 52 may be supplied with cleaning fluid 54 from print head 22.

Absorption member 56 comprises a structure configured to absorb and hold cleaning fluid 54 within reservoir 52. Absorption member 56 is configured to stand heat emitted by heating element 66 without damage to absorption member 56. Absorption member 56 reduces spillage of cleaning fluid 54. In one embodiment, absorption member 56 comprises a porous thermally stable material which retains cleaning fluid 54 using capillary forces. Examples of absorption member 56 include, but are not limited to, reticulated foams, bonded polymer fibers, cloths, inorganic porous materials and the like. In other embodiments, absorption member 56 may be omitted.

Overflow channels 58 comprises cavities extending along a top of reservoir 52. Channels 58 are configured to receive access amounts of cleaning fluid 54 from reservoir 52. Channels 58 reduce spillage of cleaning fluid 54. In some embodiments, channels 58 may be additionally provided with a wicking or absorption material 75. In still other embodiments, channels 58 may be omitted.

Wiper blades 60 comprise bars, blades or other structures formed from one or more resiliently flexible materials. In wiper blades 60 extend along ends 76, 78 of body 50 and project above reservoir 52 so as to engage and wipe nozzles 32 of print head 22 as one or both of print head 22 and station 26 are moved relative to one another. According to one embodiment, wiper blades 60 are formed from resiliently flexible material such as molded rubber or plastic.

Because blades 60 are located at opposite ends 76, 78 of reservoir 52 and are further located proximate to reservoir 52, blades 60 assists in retaining vaporized cleaning fluid 80 (shown in FIG. 1) proximate to nozzles 32 such that a greater portion of vaporized cleaning fluid 80 is subsequently condensed upon print head 22 as schematically illustrated by condensed fluid 82 (also shown in FIG. 1). In addition, because blades 60 are located proximate to reservoir 52, blades 60 may be brought into wiping engagement with nozzles 32 at a time sooner after condensation of the cleaning fluid upon nozzles 32. Although wiper blades 60 are illustrated as being provided as part of cleaning unit 44, facilitating removal and replacement of wiper blades 60 with replacement of cleaning unit 44, in other embodiments, blades 60 may be supported by other structures at other locations. For example, as indicated broken lines, printing system 20 may alternatively include blades 60 at other locations supported by support 40. In other embodiments, service station 26 may have a greater or fewer of such wiper blades 60 or may omit wiper blades 60.

Wiper channels 62 comprise cavities extending adjacent to wiper blades 60. Wiper channels 62 are configured to receive and contain residue 34 removed by wiper blades 60. Because Channel 62 are provided as part of cleaning unit 44, channels 62 that are filled may be replaced with empty channels 62 by replacing cleaning unit 44. In other embodiments, wiper channels 62 may be provided as part of support 40 or may be omitted.

Sidewalls 64 comprise structures projecting above and alongside reservoir 52 proximate to blades 60. Sidewall 64 are spaced from one another by a distant such that sidewall 64 extend on opposite side of nozzles 32 (shown in FIG. 1) when print head 22 and cleaning unit 44 are positioned opposite to one another. Side walls 64 cooperate with blades 60 to assist in retaining vaporized cleaning fluid 80 proximate to nozzles 32 of print head 22 as it condenses to form condensate 82 upon an adjacent to nozzles 32. In one embodiment, sidewalls 64 are formed from a resiliently flexible material and have ends configured to about print head 22 to form a seal against print head 22. In other embodiments, sidewalls 64 are configured to extend into close proximity to print head 22. In still other embodiments, sidewalls 64 may be omitted.

Heating element 66 comprises one or more elements or devices configured to emit heat in sufficient amounts so as to vaporize cleaning fluid 54 within reservoir 52. In one embodiment, heating element 66 may comprise a resistive type heating element. In other embodiments, heating elements 66 may comprise other devices configured to generate heat. In one embodiment, heating element 66 includes heating structures projecting into reservoir 52 so as to be surrounded by cleaning fluid 54. In other embodiments, heating element 66 extends adjacent to reservoir 52. As shown by FIG. 2, in one embodiment, heating element 66 further extends adjacent to channel 62 so as to vaporize and dry residue and any cleaning fluids captured within channel 62. Although heating element 66 is illustrated as extending below reservoir 52, in other embodiments, heating element 66 may extend along one or more sides of reservoir 52. According to one embodiment, heating element 66 doubles as a thermal sense resistor. Passing current through the thermal sense resistor heats reservoir 52. Monitoring resistance provide an indicator of fluid presence in reservoir 66 no fluid means reduced heat transfer which means an increase in temperature of the thermal sense resistor for a given power dissipation level. In such an embodiment, heating element 66 also serves as a sensor indicating presence of cleaning fluid or the absence thereof in reservoir 52.

Communication interface 68 comprises an optical interface configured to facilitate communication between cleaning unit 44 and controller 30 while permitting cleaning unit 44 to be separated from support 40. In one embodiment, communication interface 68 is configured to cooperate with communication interface 46 to transmit power and/or control signals. In one embodiment, interfaces 46 and 68 may comprise pin and pin receiving detents or may comprise electrically conductive contact pads. In other embodiments, such communication may be performed wirelessly. In other embodiments where cleaning unit 44 is not removable with respect to support 40, interfaces 46 and 68 may be omitted, wherein heating element 66 is directly connected to controller 30.

Controller 30 comprises one or more processing units configure to generate control signals directing actuator 24 (or actuator 38) to appropriately position print head 22 and cleaning unit 44 of service station 26 relative to one another for servicing of print head 22. Controller 30 is further configured to generate control signals directing operation of heating element 66 and print head 22. Such control signals generated by controller 30 may based at least in part upon signals received from sensor 42 or other inputs.

For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (R()M), a mass storage device, or some other persistent storage. In other embodiments, hard wired circuitry may be used in place of or in combination with software instructions to implement the functions described. For example, controller 30 may be embodied as part of one or more application-specific integrated circuits (ASICs). Unless otherwise specifically noted, the controller is not limited to any specific combination of hardware circuitry and software, nor to any particular source for the instructions executed by the processing unit.

FIG. 4 is a flow diagram illustrating method 100, an example of a method by which controller 30 may at least partially service print head 22. As indicated by step 104, method 100 is begun once a decision to initiate servicing of print head 22 (shown in FIG. 1) has been made. Controller 30 initiates servicing of print head 22 according to one of several modes which may be selected by a user of printing system 20. According to a first mode, controller 30 initiates servicing of print head 22 based upon signals received from sensor 42 indicating an extent to which residue 34 has built up adjacent to nozzles 32.

According to a second alternative mode, controller 30 initiates servicing of print head 22 at predetermined or preselected times or at predetermined time intervals. For example, a user may enter, via a keyboard or other input, a particular time that servicing is to take place. A user may alternatively direct controller 30, via input, to service print head 22 every 30 minutes or once a selected amount of time has elapsed since a particular activity, such as since the last time print head 22 has been used. A user may also direct controller 30 to initiate servicing at selected threshold such as after a predetermined number of sheets have been printed upon or a certain amount of fluid has been expelled by print head 22. In some embodiments, such times or thresholds may be predetermined and stored in a memory associated with controller 30. In still other embodiments, controller 30 initiates servicing upon receiving a command from a user via a keyboard, mouse or other input of print system 20.

To initiate servicing, controller 30 generates control signals directing actuator 24 (or actuator 38) the position print head 22 and reservoir 52 of cleaning unit 44 substantially opposite to one another as shown in FIG. 1. In the particular example illustrated, such positioning results in a substantially closed volume 90 being formed between reservoir 52 and nozzles 32 by blades 60 and sidewalls 64. In other embodiments where sidewalls 64 are omitted and where blades 60 have other configurations or are provided at other locations, such positioning may alternatively result in reservoir 52 being located in close proximity to nozzles 32. Once print head 22 is positioned opposite to reservoir 52, print head 22 and cleaning unit 44 are held substantially stationary with respect to one another to allow sufficient time for an adequate amount of cleaning fluid 54 to be condensed upon nozzles 32. In other embodiments, print head 22 and cleaning and 44 may be slowly moved relative to one another, wherein such movement is sufficiently slow to permit an adequate amount of vaporized cleaning fluid 80 to condense upon print head 22.

As indicated by step 106, upon positioning of reservoir 52 opposite to nozzles 32 of print head 22 as shown in FIG. 1, controller 30 generates control signals causing cleaning fluid 54 within reservoir 52 to be vaporized into a vaporized cleaning fluid 80. In the embodiment illustrated, controller 30 generates control signals directing heating element 66 to emit heat at a temperature sufficient to vaporized cleaning fluid 54. In one embodiment, heating element 66 may be maintained at a temperature slightly below a boiling point of cleaning fluid 54, wherein heating a temperature of heating element 66 is increased upon receiving control signals from controller 30. In other embodiments, cleaning fluid 54 may be vaporized as a result of heat chemically generated by reaction of materials added to cleaning fluid 54.

As indicated by step 108, vaporized cleaning fluid 80 is permitted to condense upon print head 22 adjacent to nozzles 32 of print head 22. This condensation is schematically represented in FIG. 1 as cleaning fluid condensate 82. Condensate 82 assists in removal of residue 34 during subsequent wiping.

As indicated by step 110, after condensate 82 has formed upon print head 22, controller 30 generates control signals causing print head 22 to be wiped. In particular, controller 30 generates control signals causing actuator 24 (or actuator 38) to move print head 22 and wiper blades 60 relative to one another while wiper blades 60 are in engagement with nozzles 32 of print head 22. Such relative movement may occur in a single direction or in both directions. Such wiping removes condensate 82 along with residue 34. In embodiments which include wiping channels 62, the removed residue 34 and condensate 82 become deposited within channel 62. Thereafter, the process may be repeated for further cleaning of print head 22 or print head 22 may be moved to a position ready for printing.

FIG. 5 schematically illustrates printing system 220, another embodiment of printing system 20. Printing system 220 is similar to printing system 20 except that printing system 220 additionally includes sensor 212 and is configured to supply reservoir 52 with cleaning fluid 54. Those remaining components of print system 220 which correspond to similar components of printing system 20 are numbered similarly.

Sensor 212 comprises a device configured to sense composition of fluid within an interior 229 of print head 22. FIG. 5 illustrates portions of print head 22 broken away to illustrate interior 229. In one embodiment, interior 229 comprises firing chambers of print head 22 or volumes of space adjacent to such firing chambers. In the embodiment illustrated, sensor 212 is configured to sense or detect the degree to which the solvent or ink vehicle 231 has separated from printing fluid 233 within interior 229. According to one embodiment in which printing fluid 233 comprises a pigment-based ink, such separation results in a fluid vehicle 231 separating from a remainder of ink 233 which will have a higher concentration of pigments 235 as compared to the original on separated ink 233 and as compared to vehicle 231.

Ink vehicle 231 includes cleaning fluid 54. Cleaning fluid 54 comprises a fluid configured to be vaporized by heating element 66 and to condense upon print head 22 adjacent to nozzles 32. Cleaning fluid 54 is configured to facilitate removal of residue 34 (shown in FIG. 1) from print head 22. In one embodiment in which residue 34 results from a pigment-based ink, wherein residue 34 may largely comprise such pigments, cleaning fluid 54 is specifically configured to facilitate removal of such pigment residue. In one embodiment, cleaning fluid 54 comprises a humectant. Examples of humectants include, but are not limited to, glycerol, ethylene glycol, diethylene glycol, 2-pyrrolidinone and the like. In one embodiment, such humectants are configured to vaporize or boil at temperatures approximately 150 degrees Celsius. As a result, cleaning fluid 54 more easily vaporizes using compact and low-cost heating element 66. In other embodiments, cleaning fluid 54 may comprise other materials configured to loosen, soften, dissolve or otherwise facilitate removal of residue 34 In addition to cleaning fluid 54, vehicle 231 may include other fluids are materials as well depending upon the composition of fluid or ink 233.

In the embodiment illustrated, sensor 212 is located so as to sense a portion of interior 229 where separated vehicle 231 collects to determine the extent of vehicle separation. In another embodiment, sensor 212 may alternatively be located so as a sense a portion of interior 229 where pigments 235 collect after separation to determine an extent of vehicle separation. According to one embodiment, sensor 212 is configured to measure complex impedance of the ink. In other embodiments, sensor 212 may have other configurations. In some embodiments, sensor 212 may be omitted.

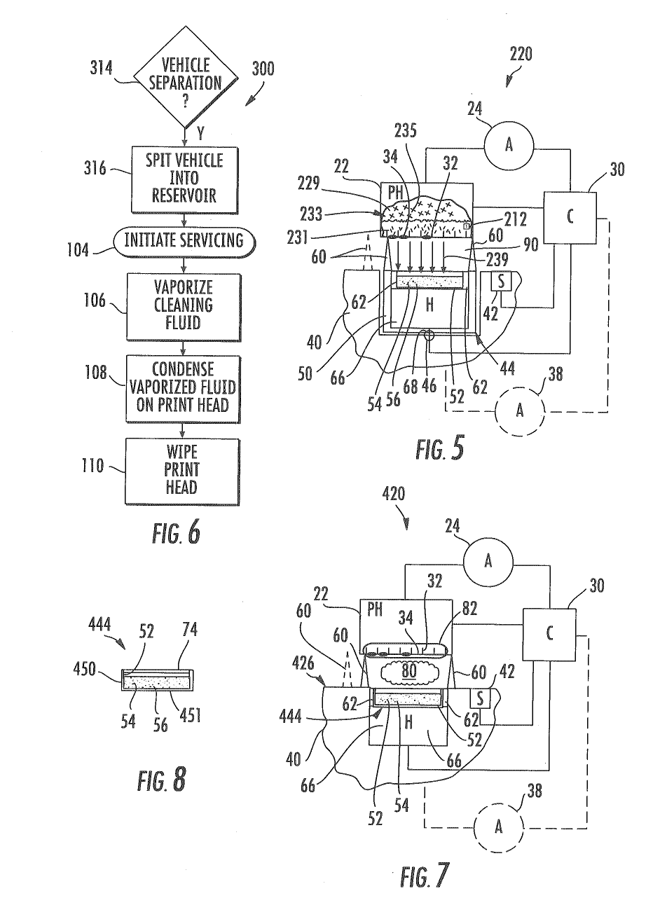

FIG. 6 is a flow diagram illustrating method 300, an example method by which printing system 220 may maintain cleaning unit 44 and may service print head 22 using cleaning unit 44. Method 300 is similar to method 100 and except that method 300 additionally includes steps 314 and 316. Those remaining steps of method 300 which correspond to method 100 are numbered similarly.

Steps 314 and 316 occur prior to the initiation of servicing of print head 22 as indicated in step 104. Although steps 314 and 316 are illustrated as occurring prior to a decision to initiate servicing (step 104) has been made, in other embodiments, steps 314 and 316 may be performed subsequent to step 104. In step 314, a determination is made as to whether the ink vehicle 231 has sufficiently separated from pigments 235 of fluid 233 (shown in FIG. 5). Such determination may be made in several fashions. In one mode, controller 30 (shown in FIG. 5) may determine whether sufficient separations occurred based upon signals received from sensor 212. In another mode, or in another embodiment, controller 30 may alternatively monitor an amount of time that has elapsed since last printing with print head 22. In particular, controller 30 may include threshold values stored in a memory, such as in a look-up table, which provide the extent of expected vehicle separation based upon the amount of elapsed time. Such values may be dependent upon such factors as the type of ink vehicle 231, the type of pigment dispersion 235, the type or characteristics of surfactants within fluid 233, environmental conditions such as environmental humidity, temperature and the like or the particular characteristics of print head 22 itself, such as its microfluidic architecture. In such embodiments, printing system 220 may include other sensors configured to detect such environmental conditions. In lieu of stored time values corresponding to degrees of vehicle separation, controller 30 alternatively include algorithms configured to calculate degrees of vehicle separation based upon one or more of such factors.

As indicated in step 316, once controller 30 has determined that vehicle 231 has sufficiently separated from a remainder of fluid 233, controller 30 generates control signals directing vehicle 231, including cleaning fluid 54, to be spit or otherwise ejected into reservoir 52 as indicated by arrows 239 in FIG. 5. In those embodiments including absorption member 56, such ejected fluid is absorbed, reducing the likelihood of splattering. As indicated by step 106, 108 and 110, be spit cleaning fluid deposited in reservoir 52 is subsequently recycled by being vaporize a condensed upon nozzles 32 to assist removal of residue 34 during wiping a print head 22.

Because print head 22 is used to provide reservoir 52 with cleaning fluid 54, a useful life of cleaning unit 44 may be prolonged by replenishing cleaning unit 54 with cleaning fluid 54. In some embodiments, cleaning unit 44 may be shipped in a dry state (without cleaning fluid 54), wherein cleaning unit 44 is initially supplied with cleaning fluid 54 upon initial use from print head 22. Because printing system 20 facilitates recycling of the cleaning fluid 54, such as humectant, the build up the residue in a spittoon is also reduced.

Cleaning unit 44 provides a less complex and low-cost mechanism for improving printing quality regardless of how reservoir 52 is applied with cleaning fluid 54. In particular, cleaning unit 44 facilitates more effective cleaning fluid assisted wiping of print head 22 and may be configured to work with most pigment inks. As a result, cleaning unit 44 facilitates the use of pigment inks in low-cost or low-and printers which are sometimes unused for prolonged periods of time.

FIG. 7 schematically illustrates printing system 420, another embodiment of printing system 20 shown in FIG. 1. Printing system 420 is similar to printing system 20 except that printing system 420 includes a service station 426 in place of service station 26. Service station 426 includes cleaning unit 444 in lieu of cleaning unit 44. Service station 426 is similar to service station 26 except that rather than being provided as part of cleaning unit 44, wiper blades 60, wiper channel 62, sidewalls 64 and heating element 66 are alternatively supported by support 40. As a result, cleaning unit 444 is simplified, reducing the cost of cleaning unit 444 and rendering cleaning unit 444 more disposable.

FIG. 8 is an enlarged sectional view of cleaning unit 444. Cleaning unit 444 includes body 450, reservoir 52, cleaning fluid 54, absorption member 56 and cover 74. Body 450 comprises a housing, frame or other structure configured to support remaining components of cleaning unit 444. Body 450 is configured to be removably received within or removably connected to support 40 so as to position reservoir 52 and cleaning fluid 54 in close proximity to heating element 66. In one embodiment, body 450 as a floor or bottom portion 451 formed from one or more materials having a high degree of thermal conductivity, such as a metal. As a result, heat is more effectively transmitted from heating element 66 to cleaning fluid 54. The remaining components of cleaning unit 444, reservoir 52, cleaning fluid 54, absorbed in member 56 and cover 74 are described above with respect to printing system 20.

According to one embodiment, cleaning unit 444 may be pre-supplied or pre-filled with cleaning fluid 54 prior to insertion or connection to support 40 of service station 426. In another embodiment, cleaning unit 444 may be supplied with cleaning fluid 54 from a print head 22 such is described above with respect to method 300. Because cleaning unit 444 comprises a relatively less complex and low-cost cartridge for replenishing servicing station 426 with cleaning fluid 54, the cost of servicing of print head 22 is reduced.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a reservoir containing a print head cleaning fluid;
a heating element configured to vaporize the cleaning fluid in the reservoir while one or more print heads are positioned adjacent to the reservoir such that the cleaning fluid deposits upon the one or more print heads sufficiently to enhance cleaning of the print heads.

2. The apparatus of claim 1 further comprising a fluid absorbing material within the reservoir.

3. The apparatus of claim 1 further comprising a removable cover sealing the cleaning fluid within the reservoir.

4. The apparatus of claim 1, wherein the reservoir is configured to receive the print head cleaning fluid from a fluid spit by the one or more print heads into the reservoir.

5. The apparatus of claim 1 further comprising a support, wherein the reservoir is removably connected to the support.

6. The apparatus of claim 5 further comprising a fluid absorbing material within the reservoir.

7. The apparatus of claim 1, wherein the reservoir includes a wick proximate a top of the reservoir.

8. The apparatus of claim 1 further comprising a controller configured to generate control signals based upon a time lapse since last printing with the one or more print heads, wherein initiation of vaporization of the cleaning fluid by heating element occurs in response to the control signals.

9. The apparatus of claim 1 further comprising:
a sensor configured to detect ink residue on the one or more print heads; and
a controller configured to generate control signals based upon sensed residue on the one or more print heads, wherein vaporization of the cleaning by the heating element occurs in response to the control signals.

10. The apparatus of claim 1 further comprising a controller configured to generate control signals based on at least one of ink vehicle, pigment dispersion, surfactants, environmental conditions and microfluidic architecture of the one or more print heads and wherein initiation of vaporization of the cleaning fluid by the heating element occurs in response to the control signals.

11. The apparatus of claim 1 further comprising resiliently flexible blades on opposite sides of the reservoir.

12. A method comprising:
vaporizing a cleaning fluid;
condensing the vaporized cleaning fluid upon a print head; and
wiping the print head.

13. The method of claim 12 further comprising:
supplying a reservoir with the cleaning fluid;
positioning the reservoir and the print head adjacent to one another; and
heating the cleaning fluid within the reservoir to vaporize the cleaning fluid and to condense the cleaning fluid on the print head.

14. The method of claim 13, wherein supplying the reservoir includes spitting the cleaning fluid from the print head into the reservoir.

15. The method of claim 13, wherein the reservoir is supplied with the cleaning fluid from a source other than the print head.

16. The method of claim 13 further comprising:
removably inserting the reservoir into a base, wherein the reservoir contains the cleaning fluid prior to insertion.

17. The method of claim 13 further comprising absorbing the cleaning fluid in the reservoir.

18. The method of claim 12 further comprising:
sensing an extent of ink residue on the print head; and
initiating vaporization of the cleaning fluid based on the sensed extent.

19. The method of claim 12 further comprising initiating vaporization of the cleaning fluid after a predetermined lapse of time since prior printing with the print head.

20. An apparatus comprising:
means for vaporizing a cleaning fluid and condensing the vaporized cleaning fluid upon a print head; and
means for wiping the condensed cleaning fluid off the print head.
